(19) United States
(12) Patent Application Publication
(10) Pub. No.: US 2016/0364574 A1
(43) Pub. Date: Dec. 15, 2016

(54) CONTENT PROJECTION OVER DEVICE LOCK SCREEN

(71) Applicant: MICROSOFT TECHNOLOGY LICENSING, LLC, REDMOND, WA (US)

(72) Inventors: Scott Plette, Kirkland, WA (US); Aaron Wesley Cunningham, Redmond, WA (US); Steven Marcel Elza Wilssens, Bothell, WA (US); Vincent Bellet, Kirkland, WA (US)

(21) Appl. No.: 14/737,057

(22) Filed: Jun. 11, 2015

(51) Int. Cl. G06F 21/62; G06F 21/60; G06F 21/31

(52) U.S. Cl. CPC G06F 21/6218; G06F 21/31; G06F 21/604

(57) ABSTRACT

Embodiments are directed to displaying content projected from a source computing device on a display of a locked target computing device. Embodiments are also directed to projecting control information onto a locked target computing device's display and allowing control of a second computing device using the control information displayed on the target computing device. In one scenario, a target computing device receives a request to display content projected from another computing system. The target computing device determines whether receiving projected content from the other computing system is permissible on the target computing device when the target computing device is in a locked state. Then, upon verifying permissibility, the target computing device provisions computing resources to display the received content while in the locked state. The target computing device may also control functions on the other computing system using control information.

### BACKGROUND

Mobile devices including smartphones, tablets and wearable devices have become commonplace in today's society. These devices provide many different kinds of functionality through applications and hardware components. Because these devices often carry a user's personal information, most users limit access to their device in some form. Indeed, most mobile and stationary devices (such as personal computers) are placed in a locked state that severely restricts use of the device until proper user credentials are entered. Typically, this use is limited to displaying calendar items, emails or other content generated by the locked device.

### BRIEF SUMMARY

Embodiments described herein are directed to displaying content projected from a source computing device on a display of a locked target computing device. Embodiments are also described herein that are directed to projecting control information onto a locked target computing device's display and allowing control of a second computing device using the control information displayed on the target computing device. The second computing device that is controlled by way of the control information projected onto the display of the locked target device can be the device that sent the control information.

In one embodiment, a target computing device receives a request to receive and display content projected from another computing device. The target computing device determines whether receiving content projected from the other computing device is permissible on the target computing device while the target computing device is maintained in a locked state. Upon verifying permission, the target computing device provisions at least some of its computing resources to display the received content on a target computing device display while the target computing device is maintained in the locked state. By allowing a target device to present content while in a locked state, ease of use of the target device is improved as content can be presented by multiple unique users without at least one user having to know an unlocking code, and without requiring any user to log onto the device.

In another embodiment, a target computing device receives a request to project content from another computer system. The target computing device determines whether receiving content projected from the other computing device is permissible on the target computing device while maintaining the target computing device in a locked state. Upon verifying permission, the target computing device provisions at least some of its computing resources to present the received content on a display of the target computing device while the target computing device is maintained in the locked state. The target computing device then receives user input including command information for controlling the other computer system, and controls the other computer system using the received command information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates an example computer architecture in which embodiments described herein may operate including providing content on a display of a locked target computing device.

FIG. 2 illustrates a flowchart of an example method for providing content on a display of a locked target computing device.

FIGS. 3A and 3B illustrate an example embodiment in which content is projected on a device's lock screen.

FIG. 4 illustrates an example embodiment in which a target computing device is used to control a computer system.

FIG. 5 illustrates a flowchart of an example method for projecting information onto the target computing device's lock screen and allowing control of a second computing device from the locked target device.

FIG. 6 illustrates an example embodiment in which received content is displayed on a home screen after login.

### DETAILED DESCRIPTION

Embodiments described herein are directed to displaying content projected from a source computing device on a display of a locked target computing device. Embodiments are also described herein that are directed to projecting control information onto a locked target computing device's display and allowing control of a second computing device using the control information displayed on the target computing device. The second computing device that is controlled by way of the control information projected onto the display of the locked target device can be the device that sent the control information.

In one embodiment, a target computing device receives a request to receive and display content projected from another computing device. The target computing device determines whether receiving content projected from the other computing device is permissible on the target computing device while the target computing device is maintained in a locked state. Upon verifying permission, the target computing device provisions at least some of its computing resources to display the received content on a target computing device display while the target computing device is maintained in the locked state. By allowing a target device to present content while in a locked state, ease of use of the target device is improved as content can be presented by multiple unique users without at least one user having to know an unlocking code, and without requiring any user to log onto the device.

In another embodiment, a target computing device receives a request to project content from another computer system. The target computing device determines whether receiving content projected from the other computing device is permissible on the target computing device while maintaining the target computing device in a locked state. Upon verifying permission, the target computing device provisions at least some of its computing resources to present the received content on a display of the target computing device while the target computing device is maintained in the locked state. The target computing device then receives user input including command information for controlling the other computer system, and controls the other computer system using the received command information.

The following discussion now refers to a number of methods and method acts that may be performed using one or more embodiments described herein. It should be noted that, although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems can take a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

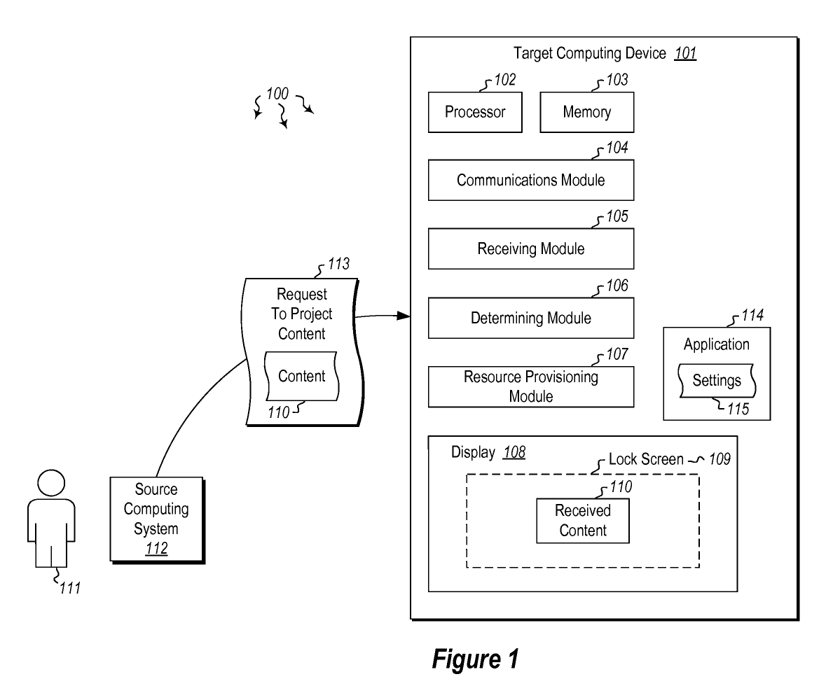

As illustrated in FIG. 1, a computing system (e.g. target computing device 101) typically includes at least one processing unit 102 and memory 103. The memory 103 may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product. An example of such an operation involves the manipulation of data. The computer-executable instructions (and the manipulated data) may be stored in the memory 103 of the computing system 101. The target computing device 101 may also contain communication channels that allow the target computing device 101 to communicate with other message processors over a wired or wireless network. Such communication channels may include hardware-based receivers, transmitters or transceivers, which are configured to receive data, transmit data or perform both.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments described herein also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, embodiments described herein may comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes the target computing device 101. The target computing device 101 may be any type of local or distributed computer system, including a cloud computing system. The term “target” may indicate that the device is the target of the projection, or in other words, the device on which content is to be displayed. The target computing device 101 includes modules for performing a variety of different functions. For instance, the communications module 104 may be configured to communicate with other computing systems. The communications module 104 may include any wired or wireless communication means that can receive and/or transmit data to or from other computing systems. The communications module 104 may be configured to interact with databases, mobile computing devices (such as mobile phones or tablets), embedded or other types of computing systems.

The target computing device 101 further includes a receiving module 105 which may be configured to receive a request to display projected content 113. The request may be received from a source computing system 112 which may be any type of computing system including a smartphone, laptop, PC, tablet, wearable device such as a watch, or other type of computing system. The term “source” may indicate that the device is the source of the projected content, or in other words, the device from which projected content is received.

The source computing system 112 may be operated by a user 111 who may issue the request 113 to project content 110. The request 113 may include content 110 or may include links to content that is downloaded or streamed from another location such as the cloud. The request to project content 113 may indicate that the content 110 is to be displayed on the display 108 of the target computing device 101. The display 108 of the target computer device 101 may currently be in a locked mode, and may be displaying a lock screen 109. As used herein, the term “lock screen” may refer to an image and/or user interface (UI) that is displayed to indicate that the target computing device 101 is in a locked state.

Upon receiving the request 113 to project content 110 at the receiving module 105, the determining module 106 may determine whether the request is to be granted. That is, the determining module 106 determines whether content 110 may be projected on the display 108 of the target computing device 101 while the target computing device 101 is in locked mode. The determining module 106 may make this determination in a variety of ways, including consulting settings 115 that are part of an application 114. For example, a user or administrator of the target computing device 101 may open application 114 (or may have opened it in the past) to configure settings 115. The settings may indicate whether displaying content while in locked mode is permissible on the target device 101.

The settings may also be more detailed and may allow or disallow certain types of content or content projected from certain applications or certain sources. The settings may specify that content may be projected from certain users or certain groups of users, while being prevented for other users. The settings may further specify certain times of day in which content projection is allowed or disallowed. Any of these settings may be combined so that, for example, the owner or administrator of target computing device 101 may specify that only certain users can project certain content at specified times during the day. Other settings may also be used in addition to those already mentioned. The application 114 may thus allow a user to control how and when their display 108 may be used to project content while locked.

In other cases, the settings regarding how and when and who may project content may be controlled by the operating system of the target computing device 101. The user of the target computing device 101 may thus specify these settings in a UI menu or using gestures or verbal commands or some other form of input to indicate the parameters under which content projection from another device is allowed while the target computing device 101 is in locked mode.

Once the determining module 106 determines that content projection is permitted from the source computing system 112 or from user 111 specifically, the resource provisioning module 107 may provision one or more processing resources including processor 102, memory 103, data storage (not shown), graphics cards (not shown) or other processing resources to the task of presenting the content 110. In some cases, the amount of target computing device 101 resources may be limited to only those resources that are needed to display the content.

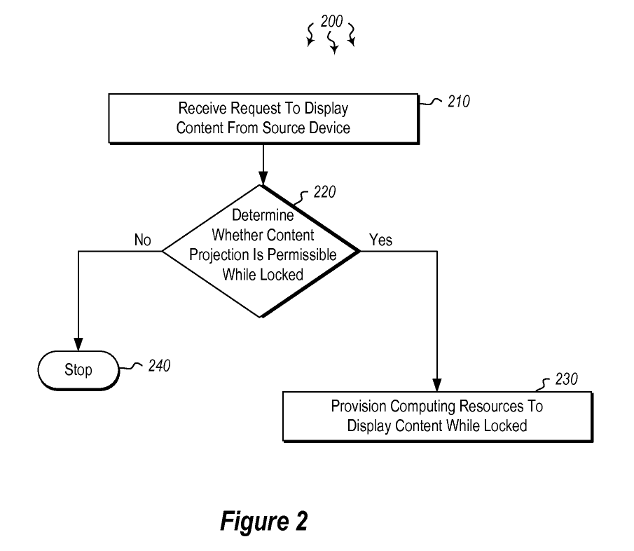

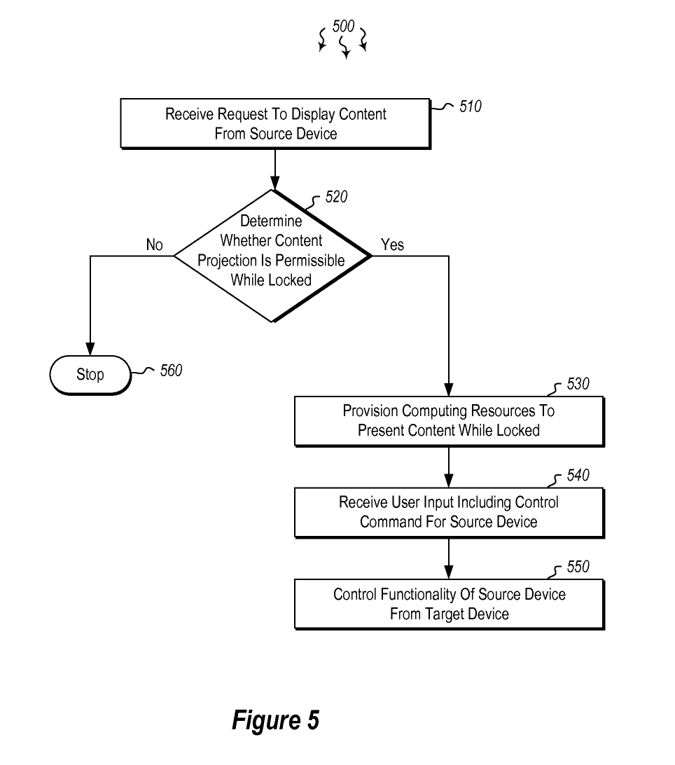

Thus, fewer resources may be provisioned when only text or images are shown, while more resources may be provisioned when multimedia content such as video content is shown on the display 108. In this manner, a projecting device may send content to a target device and have that content displayed on the target device's lock screen. In some embodiments, as will be explained further below, the target computing device 101 may be used to control one or more features of the source computing system 112. These concepts will be explained with regard to methods 200 and 500 of FIGS. 2 and 5, respectively.

In view of the systems and architectures described above, methodologies that may be implemented in accordance with the disclosed subject matter will be better appreciated with reference to the flow charts of FIGS. 2 and 5. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart 200 of a method for providing content on a display of a locked target computing device. The method 200 will now be described with frequent reference to the components and data of environment 100.

The method includes receiving a request to display content from a source computing system (Block 210). For example, receiving module 105 may receive the request 113 to display projected content 110 from computing system 112. The computing system 112 may belong to or may be used by user 111. The user may initiate an application or operating system that is configured to transmit or project content onto other computing systems. For example, the computing system 112 may include an application that can transmit images, videos, screen shots or other data to other computing systems such as the target computing device 101. The computing system 112 may broadcast or directly transfer the data or “content” 110 to the target computing device 101. In some cases, the content 110 may be transferred wirelessly, while in other cases, the content may be transferred over a wired connection to the target computing device 101.

The method includes determining whether receiving content projected from the second computing system is permissible on the target computing device 101 while maintaining the target computing device in a locked state (Block 220). The determining module 106 of the target computing device 101 may be configured to determine whether receiving content 110 projected from the computing system 112 is permissible on the target computing device 101 while the target computing device 101 is in a locked state. The determining module 106 may determine whether projection on lock is permissible by checking operating system settings or application settings 115 that have been configured previously on the target computing device 101. The settings may be set up by a user of the target device 101, or may be set up by a developer or administrator responsible for the target device.

Upon verifying that projecting content is permissible on the target device 101 while the device is in a locked state (“Yes” at Block 220), the resource provisioning module 107 may provision at least some computing resources of the target computing device 101 to present the received content on the display while the target computing device is maintained in the locked state (230). If the determining module 106 determines that projecting content is not permissible on the target computing device 101 while it is in a locked state (“No” at Block 220), the method stops (240) and no projected content is displayed on the target device 101. Alternatively, the locked target device 101 may display an indication that content projection is prohibited.

As mentioned above, the computing resources provisioned by the resource provisioning module 107 may include processing resources, memory, data storage or other computing resources. The resource provisioning module 107 may, for example, turn the display 108 on and keep it on. The resource provisioning module 107 may also enable a graphics card or graphics processor to drive the projection of the content 110 on the display 108. Using these provisioned resources, the target computing device 101 may display the content 110 received from the computing device 112 while the target computing device 101 is in a locked state.

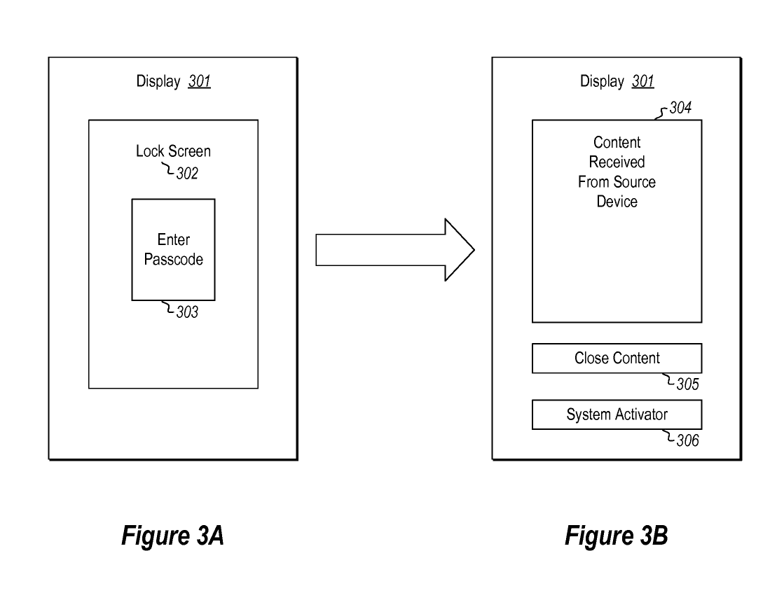

As shown in FIG. 3A, a display 301 may include a lock screen 302. The lock screen 302 may include a background image and potentially user interface elements such as buttons or fields that provide limited functionality. Some of these buttons may, for example, provide a mechanism for a user to provide a pass code 303 or other form of authentication such as biometric authentication. If the determining module 107 of FIG. 1 determines that content may be displayed on display 301, then the contents of display 301 may change to those shown in FIG. 3B. The system activator 306 may be any type of system resource activation mechanism that activates system resources to enable content rendering on the display 301. The system activator 306 may activate one or more processing, memory, graphics or other system resources to display the content 304 received from the source device.

Thus, for example, the content received from the source computing system 112 (i.e. content 304) may be displayed on the display 301. The content received from the source computer system 112 may be displayed in place of or in addition to the lock screen 302. Other buttons or interfaces may also be displayed on display 301. Such buttons may include a close content button 305 that allows a user of the target device 101 to immediately stop the projection of content on that device. Other buttons may allow manipulation of the content 304 or interaction with it. For instance, the target device may allow limited interaction with images that are being displayed including resizing or rotating the images, or may allow limited interaction with videos that are playing including pausing, skipping, rewinding or adjusting the volume.

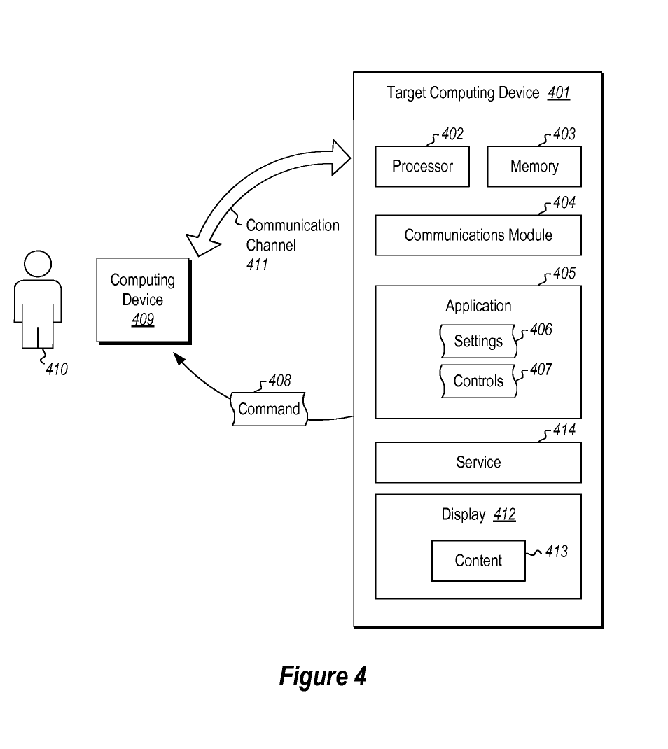

Indeed, as shown in FIG. 4, a target computing device 401 may control a computing device 409 using a communication channel 411 established between the target computing device 401 and the user's computing device 409. The target computing device 401 may be the same as or similar to target computer system 101 of FIG. 1, having a processor 402, memory 403 and a communications module 404. The target computing device 401 may also include an application 405 that allows users of the target computing device 401 to set or adjust settings that govern how and when content projection is permissible on the target computing device 401. The application 405 installed on the target computing device 401 may interact with an operating system running on the target computing device 401 to allow presentation of content 413 received from the computing device 409 while the target computing device is in a locked state. The received content 413 may be displayed on display 412 of the target computing device 401.

The application 405 may also enable the target computing device 401 to be discoverable to other computing devices. For instance, once configured, the target device may broadcast its ability to project received content, or may simply respond to a request to project content while in a locked state. The application 405 may further be configured to communicate with remote computer systems including the computing system 409. The application 405 will still prevent users from using the full functionality of the target computing device 401 (as dictated by the locked state), but may allow users of the target computing device 401 to send control commands 408 to the computing system 409 that is projecting content. The controls 407 may allow users of the target device to control functionality on the projecting device including interacting with images or videos, interacting with a browser, an office productivity program (such as a word processor or spreadsheet application) or any other type of application.

In some cases, the control commands 408 may be video game input. Indeed, the target computing device 401 may be configured to display video game controls with which the user 410 could interact. As the user 410 provided inputs on the display 412 of the target computing device 401, the inputs could be sent to the computing device 409 as control commands 408 or control information that is used to control a character or other item in a video game. Thus, in this manner, computing device 409 may be configured to run a video game (or other application) and have that video game or other application controlled by a controller displayed on display 412.

In FIG. 1, the content 110 projected from the source computing device 112 may include information received from any type of application running on that computing device. The content 110 could include operating system applications, or other applications installed on the device. The settings in application 406 of FIG. 4 may specify which applications on the projecting device are allowed to project content to the target computing device 401. Indeed, the settings 406 may be consulted by the target computing device 401 when determining whether receiving content projected from the computing system 409 is permissible on the target computing device 401 while the target computing device 401 is in a locked state. The settings 406 may be associated with or part of an application 405 or service 414 running on the target computing device 401, and may indicate which persons, devices or applications are allowed to project content on the locked target computing device 401, and when they are forbidden from doing so.

The application 406 or service 414 can be configured to run in the background of the target computing device. As such, the target computing device 401 can be ready to respond to incoming requests to project content (e.g. request 113) at any time. In other cases, the application 409 or service 414 may run on demand, such as when manually initiated by a user. In cases where the application 409 or service 414 is running in the background on the target computing device 401, the application 409 or service 414 may be initiated automatically, allowing permissibility for content projection to be established without the involvement of subsequent user input. Thus, a user of the target computing device 401 may indicate that the target computing device 401 is free to be used as a content projection device, and may thus respond to requests to project content without further input from the user.

In cases where the target computing device 401 has not been used before to project content while in a locked state, or in cases where the user of the target computing device 401 has indicated that they are to be asked for permission before displaying content on the lock screen, the application may provide a prompt allowing the user to select whether permissibility is to be granted or denied. The communications module of the target computing device 401 may open the communication channel 411 between the target computing device and the projecting computing device 409. The communication channel 411 may be opened upon determining that receiving and projecting content from the projecting computing system 409 is permissible on the target computing device 401. The communications channel 411 may also allow commands 408 to be sent back to the computing system 409 to control application functionality on that device. The communication channel 411 may use WiFi Direct, Miracast, or any other wireless or wired standard of communication between devices.

In some embodiments, the target computing device 101 of FIG. 1 is provided by one manufacturer running one operating system, and the projecting computing device 112 is provided by another, different manufacturer running a different operating system. Thus, the embodiments herein contemplate scenarios where the target and projecting computing devices are made by different device manufacturers and are running different operating systems. In such cases, requests may be received, permissibility of lock screen projection may be determined, and resources may be provisioned by controlling one or more operating system functions on the different devices. By controlling the OS functions, the target computing device 101 may be able to display content 110 from substantially any type of computing device. In some cases, the resource provisioning module 107 of the target computing device 101 invokes operating system resources to project the received content, despite the operating system being in a locked state.

In some embodiments, the receiving module 105 may receive an indication that content from the computing system 112 is no longer permitted to be projected on the target computing device 101. For example, a user of the target computing device may log in to their device and may wish to terminate any display of projected content. In other cases, a security problem may be detected, or the source computing system 112 may leave the transmission range of the target computing device 101. In still other cases, the settings 115 of application 114 may indicate that display of projected content 110 is to be terminated after a set amount of time.

If such an event occurs, the resource provisioning module 107 prevents the received content from being presented on the display 108 of the target computing device 101 by preventing the further provisioning of computing resources to the projection of that content. In other cases, the receiving module 105 may receive user input that controls functions of the projecting computing system 112. The communications module 104 may then transmit the received user input to the projecting computing system 112 to control the functions of the that computing system. In such cases, the display 108 of the target computing device 101 may act as a track pad or as a game controller or may simply display a replica of what is displayed on the source computing system 112. As such, a user of the target computing device 101 may interact with the elements displayed on display 108 to control the functionality of the source computing system 112. This will be explained further below with regard to flowchart 500 of FIG. 5.

FIG. 5 illustrates a flowchart 500 of an example method for projecting information onto the target computing device's lock screen and allowing control of a second computing device from the locked target device. The method 500 will now be described with frequent reference to the components and data of environment 100 of FIG. 1, as well as FIG. 4.

The method includes receiving a request to display content from the source computer system 112 (Block 510). For example, receiving module 105 may receive request 113 to project content 110 from the source computing system 112. The determining module 106 of the target computing device 101 then determines whether receiving content projected from the source computing device 112 is permissible on the target computing device 101 while maintaining the target computing device in a locked state (Block 520). Upon verifying that projection on the lock screen is permissible (“Yes” at Block 520), the resource provisioning module 107 (or, alternatively, the system activator 306 of FIG. 3B) provisions at least some computing resources of the target computing device 401 to present the received content 110 on a display 108 of the target computing device while the target computing device is maintained in the locked state (Block 530). If the determining module determines that projecting content is not permissible on the target computing device 101 while it is in a locked state (“No” at Block 520), the method stops (560) and no projected content is displayed on the target device 101.

The method further includes receiving user input at the target computing device 401 that includes at least one command 408 for controlling the computing device 409 (Block 540), and then controlling the projecting computer system using the received command from the target computer system 401 (Block 550). The command 408 may control substantially any functionality of the computing device 409, including application functionality and/or operating system functionality, depending on the user's rights on that computing system. In some cases, the request to project content from the computer system 409 may be received after first receiving a request from the computer system 409 to discover the target computer system 401. Indeed, the target computing device 401 may be configured to listen for and answer pings or other requests to discover the device. The request to discover the target computing device 401 may then be followed with the request to project content onto that device (e.g. request 113 of FIG. 1). If such projection is allowed, the target computing device 401 will begin provisioning computing resources to make the presentation possible.

In some cases, the user of the target computing device 401 may wish to log onto the device, despite there being content 413 displayed on the lock screen. The target computing device 401 may receive user input including credentials associated with a user (e.g. a password, pass code or biometric login). The target device may then log the user onto the target computing device 401, and continue to display the received content 413 on at least a portion of the display 412 of the target computing device 401.

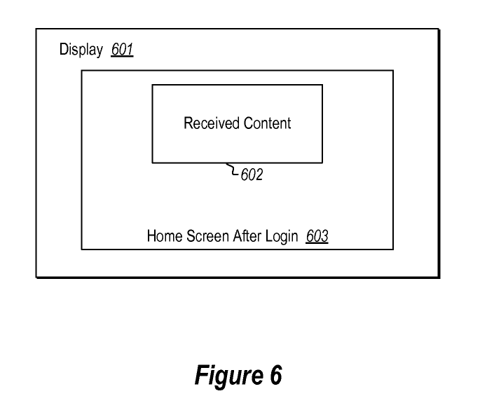

For example, as shown in FIG. 6, the received content 602 may be displayed in a portion of the display 601, while the user's home screen 603 is displayed in the remainder of the display. The home screen 603 may be the screen the user traditionally sees when they log in to the device. Thus, even in cases where projected content 602 is being displayed on a display's lock screen, the content 602 may continue to be displayed, while the traditional phone home screen 603 or other applications may be displayed in the remainder of the screen. The amount of the display 601 taken by the received content 602 may be configurable in the application 114 or in the device's operating system.

If a device user in the scenario shown in FIG. 6 ultimately decides that they no longer want the received content 602 to be displayed on their display 601, the user may simply provide input at the target computing device (e.g. 101) indicating that the received content is no longer to be presented on the target computing device. The target computing device will then discontinue displaying of the received content on the display 601.

In this manner, a user or owner of a target computing device may have control over which data is displayed during locked mode, and may further control functions of the source computing device while the source computing device is projecting content to the target computing device. It will be understood that while only one source device is shown projecting to one target display, embodiments may be implemented in which a source device projects to a plurality of target display devices, and embodiments in which multiple source devices project to a single target device. In such cases, different portions of the display may be used to show each source device's content.

Claims support: In one embodiment, a target computing device is provided that has a locked state that limits access to the device without user authentication. The target computing device 101 includes a 102, a target display 108, a receiving module 105 configured to receive a request 113 to display content 110 projected from a source computing system 112, a determining module 106 configured to determine whether receiving content projected from the source computing system is permissible on the target computing device while maintaining the target computing device in a locked state, and a resource provisioning module 107 that, upon verifying permissibility, provisions at least some computing resources of the target computing device to display the received content on the target display while the target computing device is maintained in the locked state.

In some cases, determining whether receiving content projected from the source computing system is permissible on the target computing device while maintaining the target computing device in a locked state includes accessing settings in an application or service, where the settings indicate whether receiving projected content from the source computing system is permissible. In some cases, the receiving module is further configured to receive an indication that content from the source computing system is no longer permitted to be displayed on the target computing device, and the resource provisioning module is further configured to prevent the received content from being presented on the display of the target computing device.

Still further, in some cases, the receiving module is further configured to receive user input that controls one or more functions of the source computing system, and a communications module is configured to transmit the received user input to the source computing system to control the one or more functions of the source computing system. The received content comprises information received from an application running on the source computing system. The target computing device transmits a wireless signal indicating that the target computing device is available to display content while locked. The application or service is configured to run in the background on the target computing device and is further configured to be initiated automatically, allowing content projection to be established without the involvement of subsequent input on the target computing device.

In some cases, a communications module is provided which is configured to open a communication channel between the target computing device and the source computing device upon determining that receiving content projected from the source computing system is permissible on the target computing device. Upon the occurrence of at least one specified event, display of the received content on the target display is automatically terminated.

In another embodiment, a method is provided for displaying control information on a display of a first computing device when the first computing device is in a locked state, and allowing control of a second computing device using the control information displayed on the locked first computing device. The method includes receiving a request 113 to receive projected content 110 from the second computing device 112, determining whether receiving projected content from the second computing device is permissible on the first computing device 101 when the first computing device is in a locked state, upon verifying permissibility, provisioning at least some computing resources of the first computing device to display the received content on the display 108 of the first computing device while the first computing device is maintained in the locked state, receiving user input at the first computing device, the user input including at least one command for controlling the second computing device, and controlling the second computing device using the received command 408 from the first computing device.

In some cases, the method further includes receiving input credentials associated with a user, logging the user in to the first computing device, and continuing to present the received projected content on at least a portion of the display of the first computing device. The method also includes receiving an input at the first computing device indicating that the received projected content is no longer to be presented on the first computing device, and discontinuing presentation of the received content on the display of the first computing device. An application installed on the first computing device allows control of the second computing device, but prevents changes to the application without proper authentication.

In another embodiment, a computer-readable storage media is provided having stored thereon computer-executable instructions that, when executed by one or more processors of a computing system, cause the computing system to perform a method for displaying content on a display of a locked target computing device. The method includes receiving a request 113 to display content 110 projected from a source computing system 112 on a target display 108 of the target computing device 101, determining whether receiving projected content from the source computing system is permissible on the target computing device while maintaining the target computing device in a locked state, and upon verifying permissibility, provisioning at least some computing resources of the target computing device to display the received content on the target display 108 while the target computing device 101 is maintained in the locked state. An application installed on the target computing device interacts with an operating system running on the target computing device to allow presentation of content received from the source computing system while the target computing device is in a locked state.

Accordingly, methods, systems and computer program products are provided which provide content on a display of a locked target computing device. Moreover, methods, systems and computer program products are provided which project information onto the target computing device's lock screen and allowing control of a second computing device from the locked target device.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A target computing device comprising a memory containing computer executable instruction which, when executed on a processor of the target computing device, cause the target computing device to be configured with an architecture that allows a source computing system to project content displayed at the target computing device even when the target computing device is in a locked state that limits access to the target computing device without user authentication, and wherein the architecture of the target computing device comprises:
a receiving module that receives a request to display content projected from a source computing system, and wherein the request includes the content to be displayed;
a determining module that determines whether the requested content projected from the source computing system is permissible on the target computing device even though the target computing device is in a locked state that limits access to the target computing device without user authentication, and wherein the determining module determines permissibility of the requested content projected from the source computing system by accessing operating system settings or application settings previously configured on the target computing device; and
a resource provisioning module that, in response to verification of permissibility by the determining module, provisions computing resources of the target computing device to display the content received from the source computing system at a display of the target computing device while the target computing device is maintained in the locked state, and wherein the provisioned resources are limited to resources needed for display of the requested content in accordance with the nature of the requested content.

2. The target computing device of claim 1, wherein the provisioned resources limited to resources needed for display of the requested content in accordance with the nature of the requested content are provided by a system activator module that is included in the architecture of the target computing device.

3. The target computing device of claim 1, wherein permissibility of the requested content projected from the source computing system is determined by accessing application settings of an application running in the background of the target computing device.

4. The target computing device of claim 3, wherein the application running in the background of the target computing device is initiated automatically, allowing the requested content projection to be established without involvement of subsequent input at the target computing device.

5. The target computing device of claim 3, wherein the application running in the background on the target computing device enables the target computing device to be discoverable to other computing devices.

6. The target computing device of claim 1, wherein when the requested content projected from the source computing system is displayed at the target computing device, additional interface buttons are displayed which permit selection of either an immediate cessation of the display of the requested content, or manipulation of how the requested content is displayed, while the target computer device is still in the locked state.

7. The target computing device of claim 1, wherein, upon the occurrence of at least one specified event, display of the received content on the target computing device is automatically terminated.

8. The target computing device of claim 1, wherein the architecture of the target computing device further comprises a communications module that opens a communication channel between the target computing device and the source computing system upon determining that the requested content projected from the source computing system is permissible for display on the target computing device.

9. The target computing device of claim 1, wherein the resource provisioning module invokes operating system resources to project the received content, despite the operating system being in a locked state.

10. The target computing device of claim 1, wherein the architecture of the target computing device further comprises a communications module that opens a communication channel between the target computing device and the source computing system upon determining that the requested content projected from the source computing system is permissible for display on the target computing device.

11. The target computing device of claim 10, wherein the receiving module also receives user input that controls one or more functions of the source computing system, and wherein the architecture of the target computing device further comprises:
a communications module configured to transmit the received user input to the source computing system to control one or more functions of the source computing system.

12.-20. (canceled)

21. A computer implemented method that allows a source computing system to project content displayed at a target computing device even when the target computing device is in a locked state that limits access to the target computing device without user authentication, the computer-implemented method being performed by one or more processors executing computer executable instructions for the computer-implemented method, and the computer-implemented method comprising:
receiving at a target computing device a request to display content projected from a source computing system, and wherein the request includes the content to be displayed;
determining at the target computing device whether the requested content projected from the source computing system is permissible on the target computing device even though the target computing device is in a locked state that limits access to the target computing device without user authentication, and wherein the determining module determines permissibility of the requested content projected from the source computing system by accessing operating system settings or application settings previously configured on the target computing device; and
in response to verification of permissibility, provisioning at the target computing device resources to display the content received from the source computing system at a display of the target computing device while the target computing device is maintained in the locked state, and wherein the provisioned resources are limited to resources needed for display of the requested content in accordance with the nature of the requested content.

22. The computer-implemented method of claim 21, wherein the provisioned resources limited to resources needed for display of the requested content in accordance with the nature of the requested content are provided by a system activator module that is included in the architecture of the target computing device.

23. The computer-implemented method of claim 21, wherein permissibility of the requested content projected from the source computing system is determined by accessing application settings of an application running in the background of the target computing device.

24. The computer-implemented method of claim 23, wherein the application running in the background of the target computing device is initiated automatically, allowing the requested content projection to be established without involvement of subsequent input at the target computing device.

25. The computer-implemented method of claim 23, wherein the application running in the background on the target computing device enables the target computing device to be discoverable to other computing devices.

26. The computer-implemented method of claim 21, wherein when the requested content projected from the source computing system is displayed at the target computing device, additional interface buttons are displayed which permit selection of either an immediate cessation of the display of the requested content, or manipulation of how the requested content is displayed, while the target computer device is still in the locked state.

27. The computer-implemented method of claim 21, wherein, upon the occurrence of at least one specified event, display of the received content on the target computing device is automatically terminated.

28. The computer-implemented method of claim 21, wherein the architecture of the target computing device further comprises a communications module that opens a communication channel between the target computing device and the source computing system upon determining that the requested content projected from the source computing system is permissible for display on the target computing device.

29. The computer-implemented method of claim 21, wherein the resource provisioning module invokes operating system resources to project the received content, despite the operating system being in a locked state.

30. The computer-implemented method of claim 21, wherein the architecture of the target computing device further comprises a communications module that opens a communication channel between the target computing device and the source computing system upon determining that the requested content projected from the source computing system is permissible for display on the target computing device.

31. The computer-implemented method of claim 30, wherein the receiving module also receives user input that controls one or more functions of the source computing system, and wherein the architecture of the target computing device further comprises:
a communications module configured to transmit the received user input to the source computing system to control one or more functions of the source computing system.

32. A computer-readable storage device storing computer-executable instructions which, when executed by one or more processors, implement method that allows a source computing system to project content displayed at a target computing device even when the target computing device is in a locked state that limits access to the target computing device without user authentication, and the method comprising:
receiving at a target computing device a request to display content projected from a source computing system, and wherein the request includes the content to be displayed;
determining at the target computing device whether the requested content projected from the source computing system is permissible on the target computing device even though the target computing device is in a locked state that limits access to the target computing device without user authentication, and wherein the determining module determines permissibility of the requested content projected from the source computing system by accessing operating system settings or application settings previously configured on the target computing device; and
in response to verification of permissibility, provisioning at the target computing device resources to display the content received from the source computing system at a display of the target computing device while the target computing device is maintained in the locked state, and wherein the provisioned resources are limited to resources needed for display of the requested content in accordance with the nature of the requested content.
